(19) United States
(12) Patent Application Publication
(10) Pub. No.: US 2024/0308045 A1
(43) Pub. Date: Sep. 19, 2024

(54) SCRENCH TOOLS FOR CHAINSAWS

(71) Applicant: Milwaukee Electric Tool Corporation, Brookfield, WI (US)

(72) Inventors: Jake Teitler, Brookfield, WI (US); Patrick Schmidt, Brookfield, WI (US); Scott Libert, Brookfield, WI (US)

(21) Appl. No.: 18/601,405

(22) Filed: Mar. 11, 2024

Related U.S. Application Data
(60) Provisional application No. 63/451,770, filed on Mar. 13, 2023.

(51) Int. Cl. B25F 1/00; B25F 5/02; B27B 17/02; B27B 17/12

(52) U.S. Cl. CPC B25F 1/00; B25F 5/029; B27B 17/02; B27B 17/12

(57) ABSTRACT

Scrench tools for chainsaws are provided. A scrench tool includes a first shaft extending from a first end to a second end, wherein the first end comprises a recessed slot having an opening at the first end; and a second shaft extending away from the first shaft to a screwdriver head.

The present application claims the benefit of priority to U.S. Provisional Patent Application No. 63/451,770, filed Mar. 13, 2023, the disclosure of which is incorporated by reference herein in its entirety.

### FIELD

Power tools are generally utilized in lieu of hand tools. Power tools can perform the same, or similar, tasks as hand tools at higher efficiency, allowing the operator controlling the power tool to use less effort in achieving a task. For example, chainsaws can cut through wood faster than traditional handsaws.

### BACKGROUND

Higher efficiency and performance may be achieved by using a motive device, such as a gas engine or electric motor, to drive a working implement of the power tool. These engines and motors can generally be operable at variable speeds controlled by the operator through an actuator. For example, chainsaws move a chain about an outer track of a guide bar at increasing speeds as the actuator is further depressed. Chainsaws may further incorporate lubricant systems to store lubricant that can be used for lubricating the chain, outer track, or other components. However, as power tools are used for extended periods of time, they may require periodic maintenance for continued performance.

Accordingly, improved tools which can assist in maintaining or adjusting a power tool is desired in the art. In particular, scrench tools which provide multiple tool functionality for maintaining chainsaws would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a scrench tool for a chainsaw is provided. The scrench tool includes a first shaft extending from a first end to a second end, wherein the first end comprises a recessed slot having an opening at the first end; and a second shaft extending away from the first shaft to a screwdriver head.

In accordance with another embodiment, a scrench tool for a chainsaw is provided. The scrench tool includes a first shaft extending from a first end to a second end, wherein the first end comprises a first socket comprising a recessed slot having an opening at the first end, and wherein the recessed slot extends in a direction substantially orthogonal to the first shaft; and a second shaft extending away from the first shaft to a screwdriver head, wherein the second shaft comprises a protrusion extending away from the screwdriver head.

In accordance with another embodiment, a chainsaw system is provided. The chainsaw system includes a chainsaw and a scrench tool. The chainsaw includes a housing and a guide bar extending away from the housing, wherein an outer perimeter of the guide bar comprises a rail configured to support a chain. The scrench tool includes a first shaft extending from a first end to a second end, wherein the first end comprises a recessed slot having an opening at the first end; and a second shaft extending away from the first shaft to a screwdriver head, wherein the second shaft comprises a protrusion extending away from the screwdriver head.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a chainsaw system including a scrench tool and a chainsaw in accordance with embodiments of the present disclosure;

FIG. 2 is perspective view of a scrench tool in accordance with embodiments of the present disclosure;

FIG. 3 is perspective view of a first shaft of a scrench tool in accordance with embodiments of the present disclosure;

FIG. 4 is perspective view of a first end of a first shaft of a scrench tool in accordance with embodiments of the present disclosure; and

FIG. 5 is perspective view of a second shaft of a scrench tool in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “power tool” is intended to refer to a device which is used to perform a work operation, such as cutting materials like wood, metal, concrete, grass, or the like; trimming objects like branches; biasing fluids like air and water; and the like. By way of non-limiting example, power tools can include chainsaws or other devices that use a cutting chain that rotates around one or more components.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, a scrench tool in accordance with one or more embodiments described herein can generally include a tool that provides multiple different tool functionalities for maintaining one or more parts of a power tool, such as a chainsaw. The scrench tool can include a first shaft that has a recessed slot on one end of the first shaft. The recessed slot can be configured such that a rail for the power tool can pass therethrough. The walls defining the recessed slot can thereby clear objects or other foreign debris from the rail. The scrench tool can further include a second shaft that extends away from the first shaft. The second shaft can include a screwdriver head at an open end of the second shaft that is distal the first shaft. The screwdriver head may further include a protrusion extending away from the screwdriver head. The screwdriver head and protrusion can be used for additional maintenance tasks, such as cleaning an outlet port of a lubricant system of the same power tool.

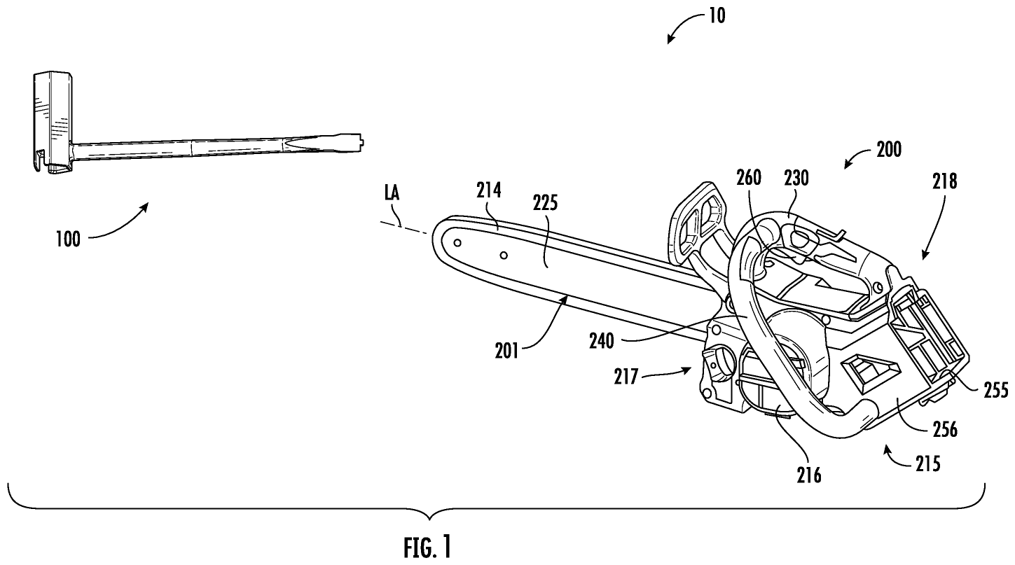

Referring now to the drawings, FIG. 1 illustrates a power tool system 10 comprising a scrench tool 100 and a power tool 200 in accordance with an exemplary embodiment of the present disclosure. More particularly, FIG. 1 illustrates a chainsaw system 10 wherein the power tool is a chainsaw 200 in accordance with an exemplary embodiment of the present disclosure. In some embodiments, the scrench tool 100 may be configured to be selectively stored on the chainsaw 200. For instance, the chainsaw 200 may have one or more recesses, snaps, loops, or similar securement features for releasably storing the scrench tool 100 therein. In other embodiments, the scrench tool 100 and chainsaw 200 may be separate components with no temporary attachment compatibility.

The chainsaw 200 generally includes a housing 215 and a guide bar 225 comprising an elongated body that extends from a front portion 217 of the housing 215. The guide bar 225 can have a rail 201 around its outer perimeter. The chainsaw 200 can further include a chain 214 that is movably coupled around a geartrain and the guide bar 225 (e.g., via an outer track 101). The rail 201 of the guide bar 225 can be configured to support the chain 214. The chain 214 includes teeth which, when moved along the guide bar 225, cause the chain 214 to cut into material, such as logs and branches.

The chainsaw 200 can include a variety of features and configurations to facilitate the handling and operation of the chainsaw 200 by a user. For instance, as illustrated in FIG. 1 the housing 215 includes a first handle 230 (e.g., a top handle) coupled between a battery pack receiving receptacle 255 and the front portion 217 of the housing 215. As such, the first handle 230 extends in a direction along the longitudinal axis LA of the guide bar 225. In addition, the housing 215 includes a second handle 240 (e.g., an elongated curved bar) coupled between the first handle 230 and a sidewall 256 of the battery pack receiving receptacle 255. The illustrated second handle 240 extends beyond a first side 216 of the housing 215 and includes a central axis that is generally U-shaped.

The first handle 230 includes an actuator 260 operable to actuate the drive state of a motive device. That is, when depressed, the actuator 260 can engage the motive device to rotate the chain 214 by causing one or more gears in a geartrain to spin. As the actuator 260 is depressed further, a speed of the motive device can increase from zero speed to a maximum speed. In this regard, the actuator 260 may variably affect the speed of the motive device between a stopped speed, which occurs when the actuator 260 is not depressed, and a maximum speed, which occurs when the actuator 260 is fully depressed.

The motive device comprises any generational source of power to directly, or indirectly, move the chain 214 around the guide bar 225. That is, the motive device can be operatively coupled to the geartrain to selectively drive the geartrain and cause rotational movement of the chain 214 around the guide bar 225. For instance, in some embodiments, the motive device may comprise a gas powered engine. In some embodiments, the motive device can comprise an electric motor. The motive device can be positioned in any suitable location within or about the housing 215 that facilitates an operational connection with the chain 214. For instance, the motive device can be positioned on the first side 16 of the housing 215 coupled to the second handle 40 as illustrated in FIG. 1.

The chainsaw 10 can further include the lubricant system internal the housing 215 for lubricating the chain intermittently, periodically, or continuously during operation. For instance, the lubricant system can include a pump having a spur gear engageable with the worm gear of the drive shaft. The pump can include an inlet port coupled to an outlet of a lubricant reservoir by a first conduit. The pump can also include an outlet port positioned opposite the inlet port. The outlet port can comprise or be coupled to a nozzle by a second conduit. Accordingly, the motive device drives the lubricant system by the drive shaft for the pump to eject a lubricant (e.g., cutting chain oil) within the lubricant reservoir from the outlet port. The outlet port is positioned adjacent the guide bar 225 and the chain 214 to dispense the lubricant on the chain 214 during operation.

The lubricant system may be adjustable or non-adjustable. For instance, the lubricant system can be manually adjustable to regulate an amount/rate of lubricant being pumped to the chain 214. For example, an adjustable lubricant pump system can include a pump shaft that rotates and reciprocates within a pump body and a cam shaft that engages the pump shaft to limit a stroke length of the pump shaft as the pump shaft reciprocates. The operator can then adjust the cam shaft causing an increase or a decrease in the stroke length of the pump shaft and a resultant change in the oil output of the adjustable lubricant pump system.

However, through continued use of operation of the chainsaw 200, it may become necessary to perform maintenance on one or more components of the chainsaw 200. For instance, the rail 201 may have debris or foreign objects disposed thereon. Additionally, it may become necessary to access the lubricant system if the outlet port becomes clogged or blocked with debris. Moreover, it may be necessary to add lubricant to the reservoir. In some instances, accessing the outlet port and/or adding lubricant may require removing a portion of the housing 215, such as removing a plate by unscrewing one or more bolts. These collective operations may require a variety of separate tools that can become cumbersome or misplaced.

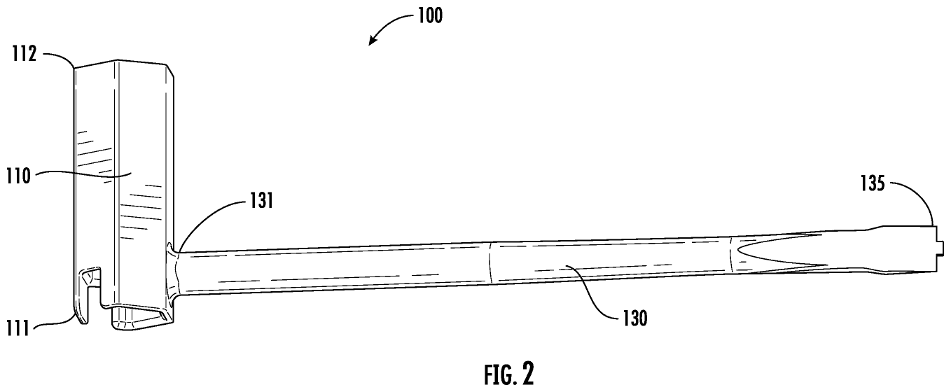

Referring now to FIG. 2, a perspective view of the scrench tool 100 is illustrated in isolation. The scrench tool 100 combines multiple tool features into a single tool. The multiple tool features can be utilized on the same power tool, such as the chainsaw 100 illustrated in FIG. 1, to provide an operator a single tool that has all necessary features for the desired maintenance operation(s). For instance, the scrench tool 100 can include the necessary features for cleaning or maintaining the track of the guide bar or the chain itself, in addition to adding lubricant or clearing the outlet ports of debris. The scrench tool 100 avoids the operator having to carry and transition between multiple independent tools while working on the same power tool.

The scrench tool 100 generally includes a first shaft 110 and a second shaft 130 extending from the first shaft 110. Both the first shaft 110 and the second shaft 130 can include one or more tool features as disclosed herein.

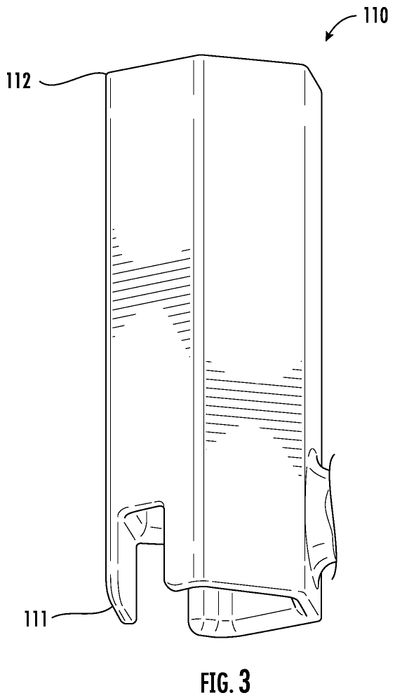

With additional reference to FIG. 3, a perspective view of the first shaft 110 is illustrated in isolation. As illustrated, first shaft 110 extends from a first end 111 to a second end 112. The first shaft 110 may extend in a generally linear direction as illustrated, or may include one or more bends, curves, or other contours between the first end 111 and second end 112. Moreover, the first shaft 110 may include a solid piece, or may have one or more hollow portions. For instance, as will be discussed herein, at least a portion of the first shaft 110 and the first end 111 may be substantially hollow. In some embodiments, the entire first shaft 110 may be hollow from the first end 111 to the second end 112. The exterior of the first shaft 110 can comprise any configuration suitable for handheld operation by a user. For instance, the first shaft 110 may have a smooth surface, a textured surface, a contoured surface, or combinations thereof.

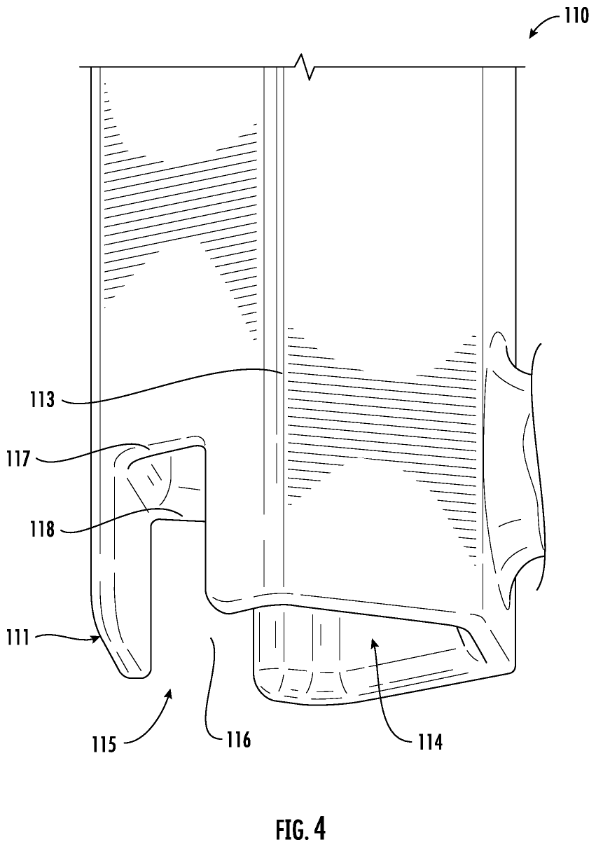

With additional reference to FIG. 4, the first end 111 of the first shaft 110 is illustrated. The first end 111 of the first shaft 110 includes one or more tool features for maintenance on a power tool, such as the chainsaw 200 illustrated in FIG. 1. For instance, the first end 111 can include a rail clearing feature and potentially a socket feature for one or more maintenance operations.

That is, the first end 111 of the first shaft 110 can include a recessed slot 115 having an opening 116 at the first end 111. The recessed slot 115 is configured to allow a rail of a power tool to pass therethrough. For instance, the recessed slot 115 can be configured to have a rail of a chainsaw guide bar pass therethrough such that the rail can become at least partially cleared of debris thereon.

In some embodiments, the recessed slot 115 may be a continuous passageway. For instance, if the first shaft 110 is solid at the first end 111, the recessed slot 115 may pass through the first shaft such that it has two continuous sidewalls defining the recessed slot 115. However, in some embodiments, the recessed slot 115 may include a first recessed slot 117 and a second recessed slot 118 on different sides of the first end 111 of the first shaft 110. For instance, if the first shaft 110 is hollow at the first end 111, the first end 111 can include an exterior wall 113 encircling the hollow interior 114 as illustrated. The first end 111 may thus include a first recessed slot 117 and a second recessed slot 118 at different portions of the exterior wall 113. The first recessed slot 117 and second recessed slot 118 can be aligned in a linear direction that is substantially orthogonal to the first shaft 110 (i.e., the direction between the first end 111 and the second end 112).

The recessed slot 115 can have a width or widths that are sized to receive a rail of a power tool. For instance, the recessed slot 115 may have a width that is at least 5 percent larger than a thickness of the rail. In some embodiments, the recessed slot 115 may have a width that is at least 10 percent larger than a thickness of the rail. In some embodiments, the recessed slot 115 may have a width that is at least 25 percent larger than a thickness of the rail. In some embodiments, the recessed slot 115 may have a width that is at least 50 percent larger than a thickness of the rail, such as at least 100 percent larger than a thickness of the rail. The recessed slot 115 may thereby be sized to receive the rail as it passes therethrough, while being close enough in size to remove foreign debris (e.g., dirt or wood) that is disposed on the rail.

In some embodiments, the recessed slot 115 may have a non-uniform thickness, such as a tapered thickness. For instance, when the recessed slot 115 is formed via a first recessed slot 117 and a second recessed slot 118 in an exterior wall 113 of the first end 111 of the first shaft 110, the first recessed slot 117 may have a larger width than the second recessed slot 118. Such embodiments may allow for easier initial receiving of the rail in the larger slot, complimented by greater debris clearing via the smaller slot. Alternatively, in some embodiments, the recessed slot 115 (e.g., the first recessed slot 117 and the second recessed slot 118) may have a common width.

In some embodiments, the first shaft 110 may further include a socket feature. For instance, as illustrated in FIG. 4, the first end 111 of the first shaft 110 can have a hollow interior, wherein the interior surface of the exterior wall 113 is configured as a socket. That is, the interior surface of the exterior wall 113 may be shaped to receive a head of a fastener, such as a bolt. In some embodiments, the interior surface of the exterior wall 113 may comprise six sides, as illustrated such that it can receive a bolt head. In some embodiments, the exterior wall 113 itself may comprise six sides. However, in some embodiments, the exterior wall 113 may have a substantially circular outer surface, whereas the interior surface of the exterior wall 113 has six sides.

The socket of the first shaft 110 may be sized and shaped to receive a particular fastener, or sized and shaped to receive a standard fastener of a particular size. In some instances, the first shaft 110 may have a first socket at the first end 111 and a second socket at the second end 112. In such embodiments, the first socket and second socket may have different sizes to accommodate different fasteners (e.g., two differently sized bolts).

With reference back to FIG. 2, the scrench tool 100 further includes the second shaft 130 extending away from the first shaft 110. That is, the second shaft extends away from the first shaft 110 at a connection end 131 towards a screwdriver head 135. The screwdriver head 135 is thereby distal the first shaft 110 with respect to the connection end 131.

The second shaft 130 may be connected to the first shaft 110 at the connection end 131 via any suitable configuration. For instance, the first shaft 110 and the second shaft 130 may be integral with one another, such as through a single cast process during manufacturing. In some embodiments, the connection end 131 of the second shaft 130 may be welded onto the first shaft 110. In some embodiments, the second shaft 130 may be releasably connected to the first shaft 110, such that the first shaft 110 and the second shaft 130 can be combined or separated based on the needs of the operator.

The second shaft 130 can extend from the first shaft 110 at any suitable location between the first end 111 and the second end 112 of the first shaft 110. For instance, the second shaft 130 may extend from the first shaft 110 at a location that is substantially halfway between the first end 111 and the second end 112. Alternatively, the second shaft 130 may extend from the first shaft 110 at a location that is closer to either the first end 111 or the second end 112 such that the second shaft 130 is offset from a midpoint. For instance, as illustrated in FIG. 2, the second shaft 130 may extend from the first shaft 110 at a location that is closer to the first end 111 than the second end.

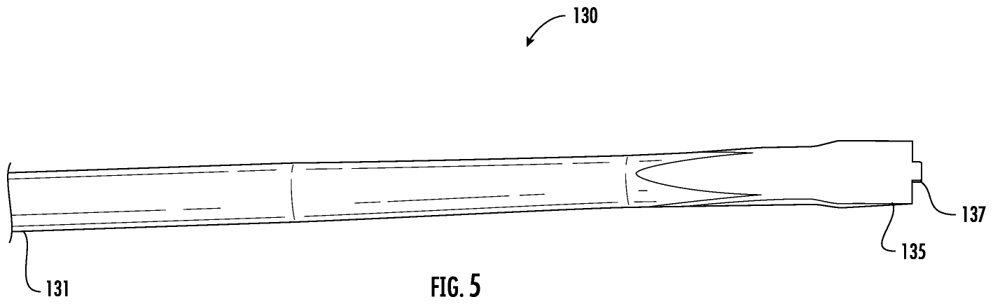

With additional reference to FIG. 5, a perspective view of the second shaft 130 is illustrated in isolation. As illustrated, second shaft 130 extends from a connection end 131 to a screwdriver head 135. The second shaft 130 may extend in a generally linear direction as illustrated, or may include one or more bends, curves, or other contours between the connection end 131 and the screwdriver head 135. Moreover, the second shaft 130 may include a solid piece, or may have one or more hollow portions. For instance, at least a portion of the second shaft 130 may be substantially hollow. In some embodiments, the entire second shaft 130 may be hollow from the connection end 131 to the screwdriver head 135. The exterior of the second shaft 130 can comprise any configuration suitable for handheld operation by a user. For instance, the second shaft 130 may have a smooth surface, a textured surface, a contoured surface, or combinations thereof.

The screwdriver head 135 may be configured for any suitable screwdriver functionality. For instance, the screwdriver head 135 may be configured as a flat head screwdriver as illustrated. In some embodiments, the screwdriver head 135 may be configured as a phillips head screwdriver. Moreover, the screwdriver head 135 can be sized to any suitable dimension. For instance, the screwdriver head 135 may be sized to be utilized on one or more components of a power tool, such as a lubricant system of a chainsaw.

Still referring to FIG. 5, the second shaft 130 further comprises a protrusion 137 extending away from the screwdriver head 135. For instance, the protrusion 137 can extend away from a tip of the screwdriver head, such as at a middle location along the tip of the screwdriver head 135.

The protrusion 137 can comprise any suitable size and shape that can be utilized to maintain a power tool. For instance, the protrusion 137 may be sized and shaped to facilitate clearing an outlet port of a lubricant system of a chainsaw. That is, the protrusion 137 may be smaller than the outlet port such that it can be at least partially inserted to remove debris therein.

In some embodiments, second shaft 130 may include a single protrusion 137. However, in some embodiments, the second shaft 130 may comprise a plurality of protrusions 137. For instance, a plurality of protrusions may extend from the tip of the screwdriver head 135, or one or more protrusions may extend from the second shaft 130 at a location other than the tip of the screwdriver head 135.

The scrench tools disclosed herein may thereby be utilized by an operator to perform a plurality of maintenance tasks without the need to rotate between different and separate tools. For instance, chainsaw systems include a chainsaw that is provided with a scrench tool, either releasably stored thereon or otherwise packaged together. The scrench tool can contain multiple functional elements to facilitate multiple maintenance operations, such as, but not limited to, rail clearing and oil port cleaning. The operator can use the single scrench tool to obtain access to the necessary components, in addition to performing the maintenance operations themselves, without the need to shuffle between multiple separate tools.

Further aspects of the invention are provided by one or more of the following embodiments:

A scrench tool for a chainsaw includes a first shaft extending from a first end to a second end, wherein the first end comprises a recessed slot having an opening at the first end; and a second shaft extending away from the first shaft to a screwdriver head.

The scrench tool of any one or more of the embodiments disclosed herein, wherein the first end of the first shaft comprises an exterior wall defining a hollow interior, wherein the recessed slot is disposed in the exterior wall.

The scrench tool of any one or more of the embodiments disclosed herein, wherein the recessed slot comprises a first recessed slot on a first portion of the exterior wall, and a second recessed slot on a second portion of the exterior wall, and wherein the first recessed slot and the second recessed slot are aligned in a direction substantially orthogonal the first shaft.

The scrench tool of any one or more of the embodiments disclosed herein, wherein the first recessed slot and the second recessed slot have a common width.

The scrench tool of any one or more of the embodiments disclosed herein, wherein the hollow interior of the first end is configured as a socket.

The scrench tool of any one or more of the embodiments disclosed herein, wherein the first end of the first shaft comprises a first socket, and wherein the second end of the first shaft comprises a second socket.

The scrench tool of any one or more of the embodiments disclosed herein, wherein the first socket and the second socket are different sizes.

The scrench tool of any one or more of the embodiments disclosed herein, wherein the screwdriver head comprises a protrusion extending away from the screwdriver head.

The scrench tool of any one or more of the embodiments disclosed herein, wherein the protrusion extends from a middle location along a tip of the screwdriver head.

The scrench tool of any one or more of the embodiments disclosed herein, wherein the second shaft extends from the first shaft at a location that is closer to the first end of the first shaft than the second end of the first shaft.

The scrench tool of any one or more of the embodiments disclosed herein, wherein the second shaft extends from the first shaft in a direction substantially orthogonal to the first shaft.

The scrench tool of any one or more of the embodiments disclosed herein, wherein the first shaft is hollow from the first end to the second end.

A scrench tool for a chainsaw includes a first shaft extending from a first end to a second end, wherein the first end comprises a first socket comprising a recessed slot having an opening at the first end, and wherein the recessed slot extends in a direction substantially orthogonal to the first shaft; and a second shaft extending away from the first shaft to a screwdriver head, wherein the second shaft comprises a protrusion extending away from the screwdriver head.

The scrench tool of any one or more of the embodiments disclosed herein, wherein the second shaft extends from the first shaft at a location that is closer to the first end of the first shaft than the second end of the first shaft.

A chainsaw system includes a chainsaw and a scrench tool. The chainsaw includes a housing and a guide bar extending away from the housing, wherein an outer perimeter of the guide bar comprises a rail configured to support a chain. The scrench tool includes a first shaft extending from a first end to a second end, wherein the first end comprises a recessed slot having an opening at the first end; and a second shaft extending away from the first shaft to a screwdriver head, wherein the second shaft comprises a protrusion extending away from the screwdriver head.

The chainsaw system of any one or more of the embodiments disclosed herein, wherein in the scrench tool is configured to be selectively stored on the chainsaw.

The chainsaw system of any one or more of the embodiments disclosed herein, wherein a width of the recessed slot is greater than a thickness of the rail.

The chainsaw system of any one or more of the embodiments disclosed herein, wherein the chainsaw comprises a lubricant system.

The chainsaw system of any one or more of the embodiments disclosed herein, wherein the lubricant system comprises an outlet port.

The chainsaw system of any one or more of the embodiments disclosed herein, wherein the protrusion is smaller than the outlet port.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A scrench tool for a chainsaw, the scrench tool comprising:
a first shaft extending from a first end to a second end, wherein the first end comprises a recessed slot having an opening at the first end; and
a second shaft extending away from the first shaft to a screwdriver head.

2. The scrench tool of claim 1, wherein the first end of the first shaft comprises an exterior wall defining a hollow interior, wherein the recessed slot is disposed in the exterior wall.

3. The scrench tool of claim 2, wherein the recessed slot comprises a first recessed slot on a first portion of the exterior wall, and a second recessed slot on a second portion of the exterior wall, and wherein the first recessed slot and the second recessed slot are aligned in a direction substantially orthogonal the first shaft.

4. The scrench tool of claim 3, wherein the first recessed slot and the second recessed slot have a common width.

5. The scrench tool of claim 2, wherein the hollow interior of the first end is configured as a socket.

6. The scrench tool of claim 1, wherein the first end of the first shaft comprises a first socket, and wherein the second end of the first shaft comprises a second socket.

7. The scrench tool of claim 6, wherein the first socket and the second socket are different sizes.

8. The scrench tool of claim 1, wherein the screwdriver head comprises a protrusion extending away from the screwdriver head.

9. The scrench tool of claim 8, wherein the protrusion extends from a middle location along a tip of the screwdriver head.

10. The scrench tool of claim 1, wherein the second shaft extends from the first shaft at a location that is closer to the first end of the first shaft than the second end of the first shaft.

11. The scrench tool of claim 1, wherein the second shaft extends from the first shaft in a direction substantially orthogonal to the first shaft.

12. The scrench tool of claim 1, wherein the first shaft is hollow from the first end to the second end.

13. A scrench tool for a chainsaw, the scrench tool comprising:
a first shaft extending from a first end to a second end, wherein the first end comprises a first socket comprising a recessed slot having an opening at the first end, and wherein the recessed slot extends in a direction substantially orthogonal to the first shaft; and
a second shaft extending away from the first shaft to a screwdriver head, wherein the second shaft comprises a protrusion extending away from the screwdriver head.

14. The scrench tool of claim 13, wherein the second shaft extends from the first shaft at a location that is closer to the first end of the first shaft than the second end of the first shaft.

15. A chainsaw system comprising:
a chainsaw comprising a housing and a guide bar extending away from the housing, wherein an outer perimeter of the guide bar comprises a rail configured to support a chain; and
a scrench tool comprising:
a first shaft extending from a first end to a second end, wherein the first end comprises a recessed slot having an opening at the first end; and
a second shaft extending away from the first shaft to a screwdriver head, wherein the second shaft comprises a protrusion extending away from the screwdriver head.

16. The chainsaw system of claim 15, wherein in the scrench tool is configured to be selectively stored on the chainsaw.

17. The chainsaw system of claim 15, wherein a width of the recessed slot is greater than a thickness of the rail.

18. The chainsaw system of claim 15, wherein the chainsaw comprises a lubricant system.

19. The chainsaw system of claim 18, wherein the lubricant system comprises an outlet port.

20. The chainsaw system of claim 19, wherein the protrusion is smaller than the outlet port.
